(19) United States
(12) Patent Application Publication
(10) Pub. No.: US 2013/0033713 A1
(43) Pub. Date: Feb. 7, 2013

(54) APPARATUS AND METHOD OF FORMING IMAGE, TERMINAL AND METHOD OF PRINT CONTROL, AND COMPUTER-READABLE MEDIUM

(71) Applicants: Elena Igorevna PATANA, Taganrog (RU); Ilya Vladimirovich SAFONOV, Moscow (RU)

(72) Inventors: Elena Igorevna PATANA, Taganrog (RU); Ilya Vladimirovich SAFONOV, Moscow (RU)

(73) Assignee: Samsung Electronics Co., Ltd, Suwon-si (KR)

(21) Appl. No.: 13/564,049

(22) Filed: Aug. 1, 2012

(30) Foreign Application Priority Data
Aug. 2, 2011 (RU) 2011132463
Jul. 19, 2012 (KR) 10-2012-0078875

(51) Int. Cl. G06K 15/02

(52) U.S. Cl. 358/1.9

(57) ABSTRACT

An image forming apparatus and an image forming method, a print controlling terminal and a print controlling method are provided. The image forming apparatus includes a storage unit which stores stereoscopic image patterns to be used for creation of a three dimensional (3D) image, a print unit which prints the stereoscopic image patterns, a user interface unit which receives at least one pattern selected from among the stereoscopic image patterns, and an image creating unit which creates the 3D image by reflecting information related to the at least one selected pattern.

### CROSS-REFERENCE TO RELATED APPLICATIONS

This application claims priority under 35 U.S.C. §119 from Russian Patent Application No. RU2011132463, filed on Aug. 2, 2011, in the Russian Federal Service for Intellectual Property (Rospatent), and Korean Patent Application No. 10-2012-0078875 filed Jul. 19, 2012, in the Korean Intellectual Property Office, the disclosures of which are incorporated herein by reference in their entirety.

### BACKGROUND OF THE INVENTION

1. Field of the Invention

Apparatuses, methods, terminals, control methods and computer-readable media consistent with what is disclosed herein relate to forming image and controlling printing, and more particularly, to an apparatus and a method of forming image to maximize a color mixing effect in the printing of anaglyph three dimensional (3D) color image, a terminal and a method of controlling printing, and a computer-readable medium.

2. Description of the Related Art

Anaglyph, lenticular lens and holography are generally known to give feeling of depth to one who sees a printed image. Among these, anaglyph relates to photographing an object with two cameras which are located away from each other at a distance corresponding to horizontal distance between left and right eyes, and printing the captured images in two colors, i.e., red and blue. When one sees the printed object through filters each in red and blue colors with left and right eyes, as the two eyes see the corresponding images, the viewer has binocular disparity and illusion of depth. This was devised by Ducos du Han ron in France, 1894. Lenticular lens was generally used in 1960 mainly to meet the increasing demands for higher resolution, and nowadays used in most printing including cards, displays, catalogues, packages, etc. Lastly, hologram reproduces wavy surfaces on the recorded solid figure, thereby providing three dimensional image of the solid figure. The hologram has been generally applied in the prints using heat transfer printing.

Anaglyph generates generally a couple of artifacts in the process of creating and printing a 3D color anaglyph image, in which one is involved with defect according to inaccurate disparity (or depth) and the other is involved with defect according to inaccurate color mixing. Certain methods resolve inaccurate disparity measurement problems through stereo-pair aligning, color compensation of corresponding aligning, and disparity map correction. The user may manage the above processes through interface. By way of example, the user may shift right- and left-eye images in relation to each other to change the depth of 3D perception.

However, the problems involved with inaccurate color mixing have not been solved yet. The main issue is the harmony between the anaglyph image color and spectrum characteristics of the glasses, and the colors of the printer. The conventional methods use the same spectrum transmittance functions which are generally known, and the glass filters have different colors from each other. As a result, the spectrum characteristics of the glasses do not match the printed colors, according to which the viewer feels ghost phenomenon when he or she sees anaglyph image through the 3D glasses. No solution has been suggested to address the above-mentioned problems yet. Considering the huge influence of the size of the printed image on the 3D perception, it is also problematic that the conventional software applications provided for the anaglyph image creation do not consider the size of the printed image.

Of course, some suggestions have been made to solve the problems occurring in the creation of the anaglyph images. However, while all these methods address the known techniques that use the spectrum transparency of the glasses, none considers the relationship between the glasses and the printed colors. Further, all these techniques do not enhance anaglyph image quality, and fail to address ways to reduce ghost effect in the anaglyph images.

FIG. 1 illustrates a conventional image printing method.

Referring to FIG. 1, the conventional image printing method generally includes creating individual images for left- and right-eyes at S101, aligning and correcting images at S103, and printing a printout at S107 by creating the anaglyph image at S105.

However, the conventional method cannot apply the spectrum transmittance function of the 3D glasses to the printed anaglyph image, and does not perform color selection of an image forming apparatus to maximize the quality of the 3D perception with respect to the anaglyph image.

### SUMMARY OF THE INVENTION

The present general inventive concept provides an apparatus and a method of forming image, a terminal and a method of controlling printing, and a computer-readable recording medium.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an image forming apparatus including a storage unit which stores stereoscopic image patterns to be used for creation of a three dimensional (3D) image, a print unit which prints the stereoscopic image patterns, a user interface unit which receives at least one pattern selected from among the stereoscopic image patterns, and an image creating unit which creates the 3D image by reflecting information related to the at least one selected pattern.

The user interface unit may perform at least one of: manual stereo-pair aligning to create the 3D image; parallax change to change depth of the 3D image; estimation of transmittance characteristic of 3D glasses; and adjustment of image size, to thereby reflect the information.

The image creating unit may create an anaglyph image as the 3D image, and the 3D glasses may use anaglyph manner.

The information according to the estimation of the transmittance characteristic of the 3D glasses may include a result of determining visibility and invisibility of the stereoscopic image pattern through the 3D glasses.

The user interface unit may execute an algorithm to adjust the information so that certain 3D glasses are adaptively used.

The foregoing and/or other features and utilities of the present general inventive concept may also be achieved by providing an image forming method including storing stereoscopic image patterns to be used for creation of a three dimensional (3D) image, printing the stereoscopic image patterns, receiving at least one pattern selected from among the stereoscopic image patterns, and creating the 3D image by reflecting information related to the at least one selected pattern.

The image forming method may additionally include estimating spectrum transmittance with respect to 3D glasses viewing the 3D image, using the stereoscopic image patterns, adjusting image information regarding the stereoscopic image of the 3D image, and creating 3D image with respect to the stereoscopic image, using the estimated spectrum transmittance and the adjusted image information.

The estimating of the spectrum transmittance may include estimating spectrum transmittance function with respect to a left-side filter of the 3D glasses, estimating spectrum transmittance function with respect to a right-side filter of the 3D glasses, and approximating a function estimate with respect to the spectrum transmittance functions of the left- and right-side filters.

The adjusting of the image information may include geometrically aligning left- and right-eye images of the stereoscopic image, compensating color of the left- and right-eye images, blurring at least one of two color channels of the left- and right-eye images, estimating a disparity map, correcting the disparity map to reduce disparity value that exceeds preset threshold, and changing the left- and right-eye images according to the corrected disparity map.

The adjusting of the image information may include geometrically aligning left- and right-eye images of the stereoscopic image, compensating color of the left- and right-eye images, blurring at least one of two color channels of the left- and right-eye images, determining if a depth map exceeds a preset threshold and if determining so, correcting the depth map to reduce a range of depth value of a stage, and changing the left- and right-eye images according to the corrected depth map.

A variable at the blurring and a variable at the changing of the disparity map and the depth map may be determined according to a size of the 3D image.

The printing of the stereoscopic image patterns may include printing a series of colors having at least one of frequency, saturation and hue that is different from each other.

The foregoing and/or other features and utilities of the present general inventive concept may also be achieved by providing a print control terminal connectible to an image forming apparatus, the terminal including a storage unit which stores stereoscopic image patterns to be used for creation of a three dimensional (3D) image, a user interface unit which receives at least one pattern selected from among stereoscopic image patterns printed at the image forming apparatus, an image creating unit which creates the 3D image by reflecting information related to the at least one selected pattern, and a communication interface unit which transmits the stereoscopic image pattern and the created 3D image to the image forming apparatus.

The user interface unit may perform at least one of: manual stereo-pair aligning to create the 3D image; parallax change to change depth of the 3D image; estimation of transmittance characteristic of 3D glasses; and adjustment of image size, to thereby reflect the information.

The information according to the estimation of the transmittance characteristic of the 3D glasses may include a result of determining visibility and invisibility of the stereoscopic image pattern through the 3D glasses.

The foregoing and/or other features and utilities of the present general inventive concept may also be achieved by providing a method for print control of a print control terminal, the method including transmitting stereoscopic image patterns to be used for creation of a three dimensional (3D) image to an image forming apparatus, receiving at least one pattern selected from among stereoscopic image patterns printed at the image forming apparatus, creating the 3D image by reflecting information related to the at least one selected pattern, and transmitting the stereoscopic image pattern and the created 3D image to the image forming apparatus.

The receiving of the at least one pattern may include estimating a spectrum transmittance with respect to a three dimensional (3D) glasses viewing the 3D image, using the stereoscopic image patterns, and adjusting image information with respect to the stereoscopic image of the 3D image, and the creating of the 3D image may include creating the 3D image with respect to the stereoscopic image using the estimated spectrum transmittance and the adjusted image information.

The estimating of the spectrum transmittance may include estimating spectrum transmittance function with respect to a left-side filter of the 3D glasses, estimating spectrum transmittance function with respect to a right-side filter of the 3D glasses, and approximating a function estimate with respect to the spectrum transmittance functions of the left- and right-side filters.

The adjusting of the image information may include geometrically aligning left- and right-eye images of the stereoscopic image, compensating color of the left- and right-eye images, blurring at least one of two color channels of the left- and right-eye images, estimating a disparity map, correcting the disparity map to reduce disparity value that exceeds preset threshold, and changing the left- and right-eye images according to the corrected disparity map.

The adjusting of the image information may include geometrically aligning left- and right-eye images of the stereoscopic image, compensating color of the left- and right-eye images, blurring at least one of two color channels of the left- and right-eye images, determining if a depth map exceeds a preset threshold and if determining so, correcting the depth map to reduce a range of depth value of a stage, and changing the left- and right-eye images according to the corrected depth map.

A variable at the blurring and a variable at the changing of the disparity map and the depth map may be determined according to a size of the 3D image.

The transmitting of the stereoscopic image patterns may include transmitting stereoscopic image patterns including a series of colors having at least one of frequency, saturation and hue that is different from each other.

The foregoing and/or other features and utilities of the present general inventive concept may also be achieved by providing a computer readable medium comprising a program to execute an image forming method may be provided, in which the image forming method may include storing stereoscopic image patterns to be used for creation of a three dimensional (3D) image, printing the stereoscopic image patterns, receiving at least one pattern selected from among the stereoscopic image patterns, and creating the 3D image by reflecting information related to the at least one selected pattern.

The foregoing and/or other features and utilities of the present general inventive concept may also be achieved by providing a print medium having an image printed according to the above-described method.

The foregoing and/or other features and utilities of the present general inventive concept may also be achieved by providing a method of an image forming apparatus, the method including creating a 3D image using information of at least one stereoscopic image pattern associated with a spectrum transmittance characteristic of 3D glass, and printing the created 3D image on a print medium.

The foregoing and/or other features and utilities of the present general inventive concept may also be achieved by providing a print medium having an image formed according to the above described method, and the print medium may further comprise 3D glass disposed on the image such that the image is exposed through the 3D glass.

In the print medium, the 3D glass may include a lenticular lens.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 illustrates a conventional image printing method;

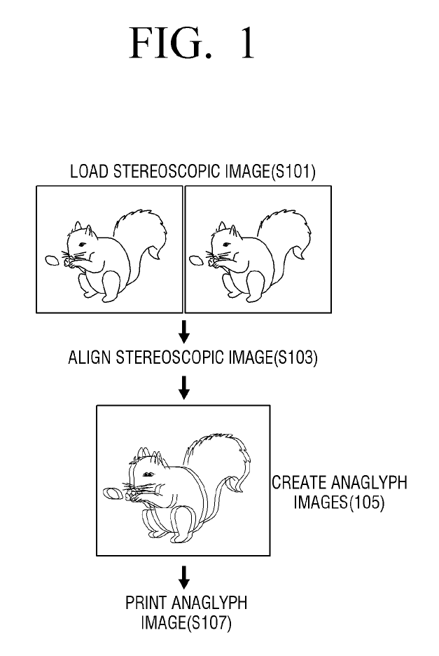

FIG. 2 is a block diagram illustrating an image forming apparatus according to an embodiment of the present general inventive concept;

FIG. 3 is a flowchart illustrating a method of driving the image forming apparatus of FIG. 2;

FIG. 4 is a flowchart illustrating an image forming method according to an embodiment of the present general inventive concept;

FIG. 5 is a view illustrating a method of using a color pattern according to an embodiment of the present general inventive concept;

FIG. 6 is a flowchart illustrating a process of estimating a spectrum transmittance function of a glass filter with respect to a color printed by an image forming apparatus;

FIG. 7 is a view illustrating a grading system according to an embodiment of the present general inventive concept;

FIG. 8 is a block diagram illustrating an image forming apparatus according to an embodiment of the present general inventive concept;

FIG. 9 is a block diagram illustrating a printing control terminal according to an embodiment of the present general inventive concept;

FIG. 10 is a flowchart illustrating an image forming method according to an embodiment of the present general inventive concept; and

FIG. 11 is a flowchart illustrating a method of controlling printing according to an embodiment of the present general inventive concept.

### DETAILED DESCRIPTION OF EMBODIMENTS

Certain exemplary embodiments of the present inventive concept will now be described in greater detail with reference to the accompanying drawings.

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. The matters defined in the description, such as detailed construction and elements, are provided to assist in a comprehensive understanding of the present inventive concept. Accordingly, it is apparent that the exemplary embodiments of the present inventive concept can be carried out without those specifically defined matters. Also, well-known functions or constructions are not described in detail since they would obscure the invention with unnecessary detail.

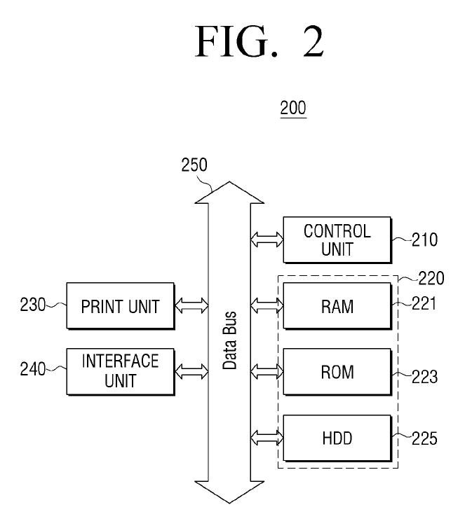

FIG. 2 is a block diagram of an image forming apparatus 200 according to an embodiment of the present general inventive concept.

Referring to FIG. 2, the image forming apparatus 200 according to an embodiment may include part or all of a control unit 210, a storage unit 220, a print unit 230, an interface unit 240, and a data bus 250, and may additionally include an image determining unit (not illustrated). Herein, the phrase “include part or all of” refers to an example in which some component(s) are integrated into another component(s), or in which specific component(s) is omitted. Hereinbelow, an example in which all of the above components are included will be explained for the sake of explanation.

The control unit 210 may control the overall operation of the storage unit 220, the print unit 230, or the interface unit 240. By way of example, the control unit 220 may control the storage unit 220 to store the image data incoming via the data bus 250, read out the stored image data from the storage unit 220, and print the read image data through the print unit 230. During this process, the control unit 210 may control or process an anaglyph image (or image) to be created with the execution of the program (or algorithm) stored at, for example, ROM 223, and output the created image to the print unit 230. Further, the control unit 210 may change the overall set values of the image forming apparatus 200 according to a command inputted through the interface unit 240. By way of example, if an estimated transmittance value of the filter with respect to certain 3D glasses is inputted through the interface unit 240, the control unit 210 may change the program stored at the ROM 223 or execute the program to reflect the estimated transmittance value during the creation of an anaglyph image. As used herein, the ‘estimated transmittance value’ of the filter with respect to certain 3D glasses may refer to a value which is selected by estimating the transmittance characteristic of the 3D glasses filter with respect to at least one pattern of the test color patterns printed at the image forming apparatus.

The storage unit 220 may store execute program to execute the image forming apparatus 200, image data inputted from an outside of the image forming apparatus, and separate program implementable when 3D image such as anaglyph image is created. To this end, the storage unit 220 may include a RAM 221 to temporarily store image data, a ROM 223 to store the separate program involved with the creation of the 3D image, and an HDD 225 to store execute programs, etc. However, it is possible that other examples can also be usable as the storage unit 220. For example, the image data may be stored at the HDD 225. Accordingly, the present general inventive concept is not limited to the example explained above. Further, as used herein, the ‘3D image’ may refer to a collection of stereoscopic images (or images), while the stereoscopic or anaglyph image may refer to left- and right-eye images.

The separate program stored in the ROM 223 may convert, for example, inputted 2D image data into 3D image data to create a 3D image. By way of example, if the inputted 2D image data is determined to be a right-eye image, object and background of the corresponding right-eye image may be analyzed, depth information may be extracted therefrom, and a left-eye image corresponding to the right-eye image may be created using the extracted depth information. After that, anaglyph image or the like may be created by aligning the right-eye and left-eye images, or the like. However, the above is implemented when it is assumed that the 2D image data is loaded. If the 3D image data other than the 2D image data is inputted from an external device, the anaglyph image may be created without performing a separate process of creating the left-eye image. That is, according to an embodiment, the anaglyph image may be created by reflecting only the estimated transmittance value. Given this, an image determining unit (not illustrated) may additionally be included to determine whether the inputted image is a 2D image or a 3D image.

The print unit 230 may print pixel data stored at the storage unit 220 onto a printout (a print medium) and output the same under the control of the control unit 210. If the stored pixel data is a 2D image, the print unit 230 may output the 2D image. However, if the program provided within the ROM 223 is executed, the print unit 230 may output a 3D image. The 3D image may be printed according to the estimated transmittance value of the filter with respect to predetermined 3D glasses, for example, with respect to the 3D glasses that the user of the image forming apparatus 200 wears.

The interface unit 240 may be implemented in the form of a module, and involved with the creation of 3D image if the program stored at the ROM 223 is executed. As used herein, the phrase ‘involved with the creation of a 3D image’ may refer to the possibility of creating a 3D image in consideration of the fact that the user performs manual aligning of a stereoscopic image, changing parallax to change a depth of the 3D image, estimating transmittance, and adjusting a size of an anaglyph image. The information other than the estimated transmittance value may be referred to as additional information depending on embodiments.

In one embodiment, the interface unit 240 may play a role of a connection which is connected to a separate host device, such as a computer (or print control terminal), to receive a separate adjustment value or selected value. In another embodiment, the interface unit 240 may be loaded with a separate program to calculate the above-mentioned variables. The interface unit 240 may also connect to an external device such as a server and receive firmware. Accordingly, depending on roles, the interface unit 240 according to an embodiment may be referred to as a receiving unit, or the like. In one embodiment, if algorithm is provided to the interface unit 240 in the form of, for example, firmware, the corresponding firmware may provide the program stored at the ROM 223. The above may be performed under control of the control unit 210.

The data bus 250 is a line that electrically or circuit-wise connects the components within the image forming apparatus 200 such as the control unit 210, the storage unit 220, the print unit 230 or the interface unit 240. For example, if the above components of the image forming apparatus 200 are implemented as modules, respectively, the data bus 250 may be used to transmit data among the modules of the system.

The image forming apparatus 200 may be implemented as a copier, a facsimile, a scanner, or a multi-function unit which integrates therein the above-mentioned functionalities. The image forming apparatus 200 may use, for example, a test color pattern (or etalon, template or stereoscopic image pattern) which is printed at a predetermined printer to estimate the spectrum transmittance functions (fₗ(λ), fᵣ(λ), wherein λ is wavelength) of the glasses filter. In one embodiment, the color test pattern on the image forming apparatus 200 may be printed by an operation of printing a series of colors with different frequencies, saturations and hue, and printing according to user's instruction. As used herein, the term ‘instruction’ may refer to user command directing to execute a program stored at the ROM 223 to create the 3D image upon user's request.

As a result, the image forming apparatus 200 according to an embodiment is able to improve the ghost phenomenon occurring when the anaglyph image is viewed through 3D glasses, since the image forming apparatus 200 takes the spectrum transmittance function of the filter with respect to predetermined 3D glasses into consideration, i.e., the image forming apparatus 200 adjusts information related to the anaglyph image to be printed.

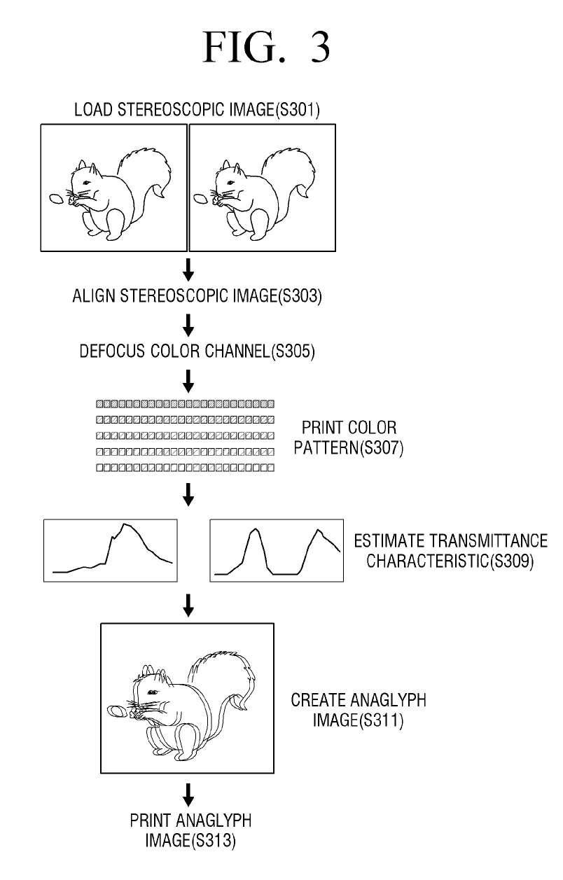

FIG. 3 is a flowchart illustrating a method of driving an image forming apparatus according to an embodiment of the present general inventive concept.

Referring to FIG. 3 along with FIG. 2 for convenience of explanation, the image forming apparatus 200 according to an embodiment may load a stereoscopic image, such as a 3D image, from an outside thereof at operation S301, or alternatively, create a 3D image using a 2D image in an event the 2D image is loaded. By way of example, the image forming apparatus 200 may determine that the inputted 2D image is a right-eye image, and thus analyze characteristics such as object and background of the 2D image and calculate depth information. Using the calculated depth information, the image forming apparatus 200 may create a left-eye image corresponding to the right-eye image.

Further, at operation S303, the image forming apparatus 200 may align the right- and left-eye images to create a stereoscopic image. As used herein, the expression ‘aligning’ may refer to arranging a left-eye image on a preceding right-eye image of a unit frame.

Next, the image forming apparatus 200 may create an anaglyph image by a projection method which takes into account the spectrum transmittance function of the filter with respect to predetermined 3D glasses. The above process may be substantially implemented by executing a program which is provided to create an anaglyph image reflecting the spectrum transmittance function estimated through the operations at operations S305 to S309. Since the image forming apparatus 200 performs the operations at operations S305 to S309 by executing a corresponding program, the above may be included as an image forming method.

If it is assumed that the image forming apparatus 200 performs an operation to reflect the spectrum transmittance rate, the image forming apparatus 200 may, first, perform color channel (red, blue) defocusing at operation S305. The color channel defocusing may be understood as, for example, a process to create a series of colors with different frequencies, saturations and hue, and print the same.

Accordingly, at operation S307, the image forming apparatus 200 prints a test color pattern (or table). As used herein, the ‘pattern’ may be a series of colors tabulated on a hue plane of an HSL color space (saturation: 0˜360°, 0˜1) or on a color plane. The colors in this space represent dependency of the colors on wavelength (λ) pretty well. The rows of the table represent hue in 0° to 330° range. The columns of the table represent the colors with saturation/purity of 1 to 0.2. In one embodiment, the series of colors on the table may be referred to as a plurality of patterns or stereoscopic image patterns.

Next, the image forming apparatus 200 at operation S309 may estimate a transmittance characteristic of the glasses filter with respect to the print pattern. While the above process substantially depends on the matching of visibility levels of the user, eventually, the image forming apparatus 200 can be understood as performing a process of processing estimated values which are generated as a result of the estimation. For example, the user may implement selection or adjustment to cause the estimated value to be reflected, according to which the image forming apparatus 200 may process the information regarding the corresponding estimated value. In other words, the corresponding estimated value may be reflected in the program to create a 3D image.

If the estimation is completed, the image forming apparatus 200 may create an anaglyph image at operation S311 which takes into consideration the spectrum transmittance function of the filter with respect to 3D glasses, and outputs an anaglyph image on a printout (print medium) and outputs the same at operation S313.

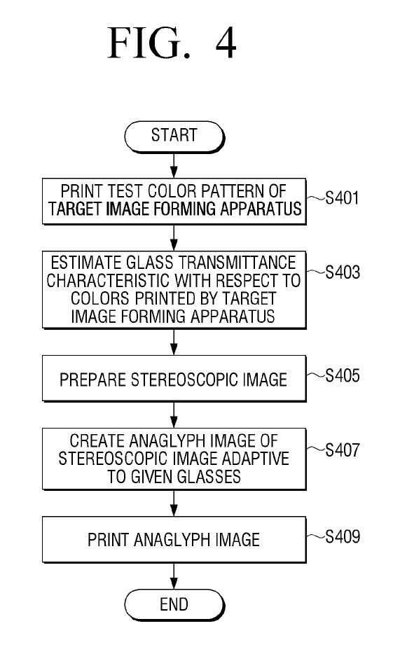

FIG. 4 is a view illustrating an image forming method according to an embodiment of the present general inventive concept.

Referring to FIG. 4 along with FIG. 2 for convenience of explanation, an image forming method in one embodiment may correspond to an operation of creating an anaglyph image by the projection method which takes into account the spectrum transmittance function of the filter with respect to predetermined 3D glasses (FIG. 3).

First, at operation S401, the image forming apparatus 200 may print a test color pattern (or stereoscopic image pattern, stereo-pair image pattern) for target printing. If a user determines that it is necessary to consider the spectrum transmittance function of the filter with respect to predetermined 3D glasses, the image forming apparatus 200 may perform the corresponding operation at operation S401 according to an incoming command. However, the above may be modified, and thus is not limited to the specific example provided above. Since the color pattern has been explained above, additional explanation will be omitted for the sake of brevity.

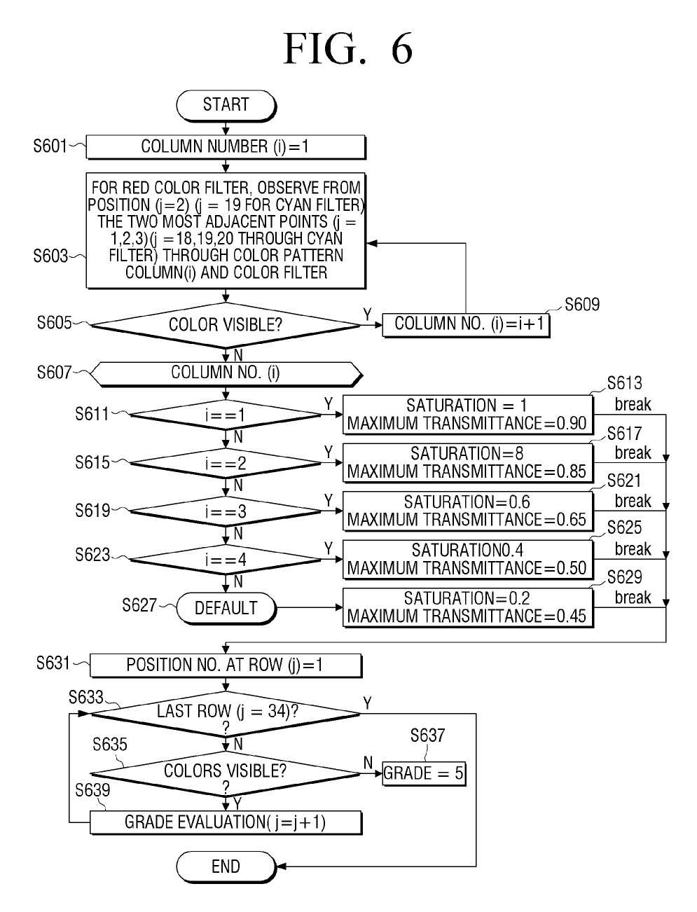

At operation S403, the image forming apparatus 200 estimates a transmittance characteristic of the glasses filter with respect to a print pattern. This process is necessary to maximize the color correspondence between the filter of the 3D glasses and the image forming apparatus 200 (e.g., printer). For example, it is assumed that the 3D glasses have red and cyan filter. The cyan is one of the three primary colors and is blue with slight feeling of green. In order to obtain an approximation function with respect to the spectrum transmittance of the glasses filter, visibility and non-visibility information of the color with respect to the pattern is estimated through the left filter and the right filter. Printing the test color pattern and estimating the spectrum transmittance function may be performed once, with respect to predetermined 3D glasses. The order of a user movement with respect to estimating the spectrum transmittance function will be explained below in greater detail with reference to FIG. 6. After matching of visibility levels by the user, it is determined which one of the actual spectrum transmittance functions of the filter is closest to the function received as a result of a user evaluation.

Further, at operation S405, the image forming apparatus 200 may perform an operation of preparing (or creating) a stereoscopic image. As used herein, the phrase ‘preparing stereoscopic image’ may well be understood as encompassing at least one of: geometrical aligning; color compensation; depth and disparity map estimation; image blurring by two color channels; and pixel information for range reduction of disparity or depth map of the image.

The geometrical aligning of the stereoscopic image may be performed in the manner explained in: Hsien-huang P. Wu and Chih-Cheng Chen “Projective Rectification with Minimal Geometric Distoration”, pp. 530, I-Tech, 2007. Further, the color compensation of an image with respect to the stereoscopic image may be performed through, for example, histogram matching. The depth map estimation may be performed in the statistical method proposed by: Hongshi Yan and Jian Guo Liu “Robust Phase Correlation Based Sub-pixel Disparity Estimation”, 4th SEAS DTC Technical Conference—Edinburgh 2009. The disparity map may be re-calculated on the depth map, and the depth map may be re-calculated on the disparity map. For various reasons, the depth map may be used in some cases, and the disparity map may be used in other cases.

The two color channels of the left- and right-eye images of the stereoscopic image, e.g., red and blue, may be blurred by an average filter. The filter variable may be determined depending on the size of the anaglyph image. Green color may not be blurred because the green color is better recognized with the human eyes than the other colors. The average filter may be expressed in the form of following mathematical formula:

$$[ Mathematical formula 1 ]$$

$$\tilde{I} ( x , y ) = \frac{1}{( 2 {N}_{x} + 1 ) ( 2 {N}_{y} + 1 )} {\sum }_{{n}_{x} = - {N}_{x}}^{{N}_{x}} {\sum }_{{n}_{y} = - {N}_{y}}^{{N}_{y}} I ( x - {n}_{x} , y - {n}_{y} )$$

where I(x, y) represents pixel magnitude of several color channels (blue, red, green), in which I(x, y)ε[0:255] is met, (x, y) refers to pixel location on the image, in which (x, y)εA×B is met, and A, B refers to a size of the image.

Ĩ(x, y) represents an average of pixel magnitudes within a square area, and the size of the square area is determined depending on the size of the printed anaglyph image.

(nₓ, n_{y}) represents the pixel location within an average window in size of Nₓ×N_{y}, Nₓ×N_{y}⊂A×B.

The range of the disparity map may decrease according to the size of the printed anaglyph image. Ghost effect may occur when a viewer sees the anaglyph image through the 3D glasses, due to interference with the waves reflected from the surface of the printed anaglyph image, and this has to be reduced. The above may be expressed in the form of mathematical formula:

\tilde{D}(i,j)=aD^{P}(i,j) [Mathematical formula 2]

where D(i, j) is a disparity value at position (i, j)εA×B before conversion (A, B represents image size), and \tilde{D}(i, j) represents disparity value at position (i, j) after conversion. “a” and “P” are constant values which are determined according to the size of the printed anaglyph image, and these meet 0≦a≦1, 0<P<1.

It is important that the disparity value is changed in the process of changing the size of the anaglyph image to maximize the quality of 3D perception. Changing the disparity may be performed non-linearly. That is, compared to the original disparity value, a larger disparity value should not be used in the event that the image size is increased, while nullification of the disparity value or loss of 3D effect should be avoided in the event that the image size is decreased. The depth map may also undergo the similar correction as the disparity map.

If all the preparatory operations from operation S401 to S405 are completed, the image forming apparatus 200 creates an anaglyph image which considers the spectrum transmittance function of the 3D glasses filter at operation S407. The direct creation of the anaglyph may be performed by the projection method proposed by: Eric Dubois “A projection method to generate anaglyph stereo images”, Proc. of ICASSP, IEEE International Conference “Acoustic, Speech, and Signal Processing”, vol. 3, pp. 1661-1664, 2001.

To be specific, the anaglyph image may be created based on the following mathematical formula in one embodiment:

\hat{V}ₐ(x)=N(R^{T}WR)⁻¹R^{T}WC₂V(x) [Mathematical formula3]

where x is a pixel location ((x, y)εA×B, A, B=image size) on the image.

Referring to <Mathematical formula 3>, it is possible that

$$R = [ {r}_{1} {r}_{2} {r}_{3} ] = [ \begin{matrix}{A}_{1} \\ {A}_{r}\end{matrix} ] ,$$

wherein [Aₗ]ₖⱼ=aₗₖⱼ=∫ p̅ₖ(λ)dⱼ(λ)Fₗ(λ)dλ, [Aᵣ]=aᵣₖⱼ=∫ p̅ₖ(λ)dⱼ(λ)Fᵣ(λ)dλ, and Fₗ(λ) and Fᵣ(λ) represent actual spectrum transmittance functions of the filters with respect to left and right filters, and λ is wavelength.

W may be expressed as a 6×6 weight factors matrix, i.e.,

$${C}_{2} = [ \begin{matrix}C & 0 \\ 0 & C\end{matrix} ] ,$$

which may be expressed as [C]ₖⱼ=cₖⱼ=∫ p̅ₖ(λ)dⱼ(λ)dλ. This represents the color matching function for the standard tintometer evaluation spectator (meaning spectrum sensitivity of eyes) approved by the International Light Association. k represents an index with respect to each color component (red, blue green) (k=1, 2, 3), dⱼ(λ) is one energy spectrum distribution of the standard tintometer illuminants, j represents an index with respect to each color component (j=1, 2, 3).

It is possible to express V(x)=[Vₗ₁(x)Vₗ₂(x)Vₗ₃(x)Vᵣ₁(x)Vᵣ₂(x)Vᵣ₃(x)]^{T}, and Vₗ(x)=[Vₗ₁(x)Vₗ₂(x)Vₗ₃(x)]_{T} represents a left-eye image of the R, G, B stereoscopic image, and Vᵣ(x)=[Vᵣ₁(x)Vᵣ₂(x)Vᵣ₃(x)]^{T} represents a right-eye image of the R, G, B stereoscopic image.

N is a normal matrix necessary to implement the condition \hat{V}ₐⱼε[0, 1], and possibly expressed as N=diag(Vₐⱼ′/Êₐⱼ) (j=1, 2, 3, index for each color component), in which Va′ refers to anaglyph vector possibly having maximum value necessary to normalize \hat{V}ₐ, which meets the condition of Vₐ′=[1 1 1]^{T} and the condition of Êₐ=(R^{T}WR)⁻¹R^{T}WC₂E.

In one embodiment, a method of preparing (or creating) a stereoscopic image may include operations of geometrically aligning left- and right-eye images of a stereoscopic image, compensating colors of the left- and right-eye images of the stereoscopic image, blurring at least one of the two color channels of the left- and right-eye images of the stereoscopic image, estimating a disparity map, correcting the disparity map with a view to reduce a disparity value that exceeds a threshold value, and changing the left- and right-eye images of the stereoscopic image according to the corrected disparity map.

Further, in an embodiment, the process of preparing (or creating) a stereoscopic image may include operations of geometrically aligning left- and right-eye images of the stereoscopic image, compensating colors of the left- and right-eye images of the stereoscopic image, blurring at least one of the two color channels of the left- and right-eye images of the stereoscopic image, estimating a depth map, correcting the depth map with a view to reduce a range of a depth value of a stage if exceeding a predetermined threshold value, and changing the left- and right-eye images of the stereoscopic image according to the corrected depth map.

After the above processes, at operation S409, the image forming apparatus 200 may print an anaglyph image which has been created at operation S407.

Of course, the color pattern printed by the predetermined image forming apparatus may be analyzed through the respective filters of the 3D glasses, by a viewer who sees the same through the 3D glasses. Accordingly, the viewer may create an anaglyph image with respect to any of the user's 3D glasses that are loaded with the color filter. Accordingly, anaglyph image brings in great 3D effect, and when viewed on a computer screen monitor, or printed on a hard copy, artifacts can be kept under minimum degree.

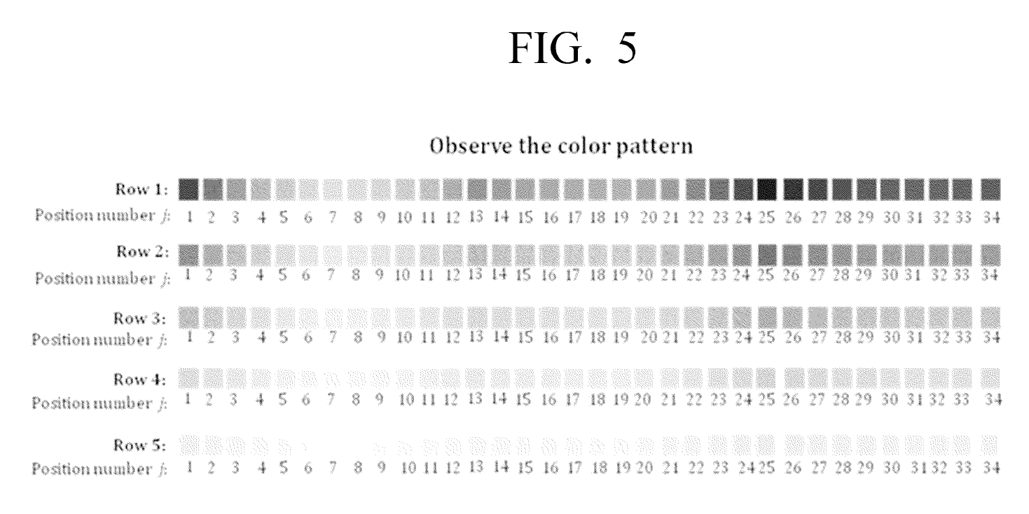

FIG. 5 is a view provided to explain a method for utilizing color pattern according to an embodiment of the present general inventive concept.

Referring to FIG. 5, a color pattern may be utilized to execute the instruction, i.e., to execute the program to create 3D image in the manner explained below.

First, the first column of the pattern is inspected through the left-side filter of the glasses and grades of the respective squares of the corresponding column are matched. For example, the grades may include 0 to 5 grades, in which 0 may indicates invisible and 5 indicates fully visible. If there is an invisible square, the column containing the corresponding square is found and visibility estimation is performed as explained above. The same operation is performed at the right-side filter. The printing in response to the instruction may be performed with respect to a series of colors which may be printed on both the same page and the following pages, or on separate pages.

As mentioned above, the ‘pattern’ refers to a series of colors tabulated on a hue (or simply, color) plane of the HSL color space (saturation: 0˜360°, 0˜1). This space represents dependency of the color on wavelength (λ) pretty well. The rows represent colors within a range of 0° to 330° (10 levels). The column of the table represents colors with saturations 1 to 0.2 (0.2 level) and purity. By way of example, glasses having a red or cyan filter are widely used. In order to obtain a spectrum transmittance function of the 3D glasses filter, it is necessary to evaluate the non-visibility of the colors using the red and cyan filters based on the patterns adjacent to the red and cyan colors. If the colors are integrated into the background, i.e., if the colors are not visible, these will pass through the filter completely. Generally, methods for estimating the spectrum transmittance functions enable estimation of the transmittance characteristic of all kinds of 3D glasses loaded with a variety of color filters.

The spectrum transmittance functions of the left- and right-side filters of the glasses may be estimated as follows. First, the spectrum transmittance function of the left-side filter is relatively roughly estimated based on the colors visible or invisible on the test color pattern which are determined by a viewer seeing the test color pattern through the left-side filter.

Next, the spectrum transmittance function of the right-side filter is relatively roughly estimated based on the colors visible or invisible on the test color pattern which are determined by the viewer seeing the test color pattern through the right-side filter.

After that, approximation may be performed, in which the spectrum transmittance function estimate is approximated to the function closest to the actual function of the filter selected from a specific set. This will be explained in greater detail below.

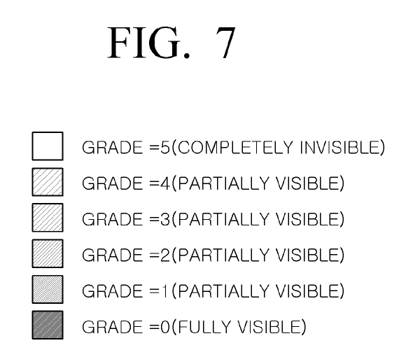

FIG. 6 is a flowchart illustrating a process of estimating spectrum transmittance function of the glass filter with respect to a color printed by an image forming apparatus, and FIG. 7 is a view illustrating a grading system according to an embodiment of the present general inventive concept.

Generally, color having 10°±10° of hue corresponds to cyan having 700 nm±27.50 nm of wavelength, cyan having 180°±10° of hue corresponds to cyan having 497 nm±3.75 nm wavelength, yellow having 500°±100° of hue corresponds to yellow having 564 nm±11.25 nm of wavelength, and green having 1200°±100° of hue corresponds to green having 530 nm±5 nm of wavelength.

At operation S601, the approximation of the spectrum transmittance function begins as the inspection of the columns of the test color pattern begins from the first column. The first column of the test color pattern corresponds to saturation/purity=1, brightness=1, and hue=0° to 330°.

It is assumed that the left-side filter of the 3D glasses is red. At operation S603, considering the fact that the three squares having 10°±10° (j=1, 2, 3) of hues correspond to red color having slight wavelength variation, and the viewer has to observe the first column with the red filter of the glasses.

At operation S605, whether the color of hue band of 10°±10° (j=1, 2, 3) is visible or not is determined. If determining invisible at operation S605, the maximum value of the spectrum transmittance function becomes 700 nm±27.50 nm at operation S607, and if determining visible at operation S605, the next column with lower saturation/purity is selected at operation S609, and then operations S603 and S605 repeat. At operation S629, if the color keeps appearing visible, it is possible to select the lowest saturation/purity column for the sake of analysis. The maximum value of the spectrum transmittance function is determined depending on the selected saturation/purity (or number of columns of the test color pattern). The saturation/purity 1; 0.8; 0.6; 0.4; 0.2 correspond to the maximum value 0.9; 0.85; 0.65; 0.50; 0.45 of the spectrum transmittance function, respectively. If the column is selected from the test color pattern, the visibility level of each color square is analyzed.

At operation S631, the current position (j) of the selected column (or number of squares) is 1.

If the current position is other than the last position of the corresponding column at operation S633, the viewer may analyze the visibility level of the color square at operation S635, and matches the respective color squares with the grades between 0 and 5 at operation S637. An example of the grade system is illustrated in FIG. 7. Referring to FIG. 7, the invisible color square is a grade 5, and the fully visible color square is a grade 0. In the current saturation/purity, the respective estimated values 0, 1, 2, 3, 4, and 5 correspond to the spectrum transmittance 0, 0.20, 0.45, 0.60, 0.85, and 1.0 which depend according to the maximum transmittance (MaxTrans).

At operation S639, the operation moves to the next position on the corresponding column.

Accordingly, the spectrum transmittance function with respect to the red filter of the predetermined glasses is estimated.

It is also assumed that the right-side filter of the 3D glasses has cyan color. Estimating the spectrum transmission function of the cyan filter is similar to the above-explained operation. The cyan color has value of 180°±10° (495 nm±5 nm). The viewer has to go through the entire sequences of the corresponding operations which are performed to estimate the spectrum transmittance function of the red filter. Note that, however, at selecting a column of operation S603, the squares having 180°±10° (j=18, 19, 20) of hue corresponds to cyan color having a slight wavelength variation.

The remaining operations are performed in a similar manner as that performed to estimate the spectrum transmittance function of the red filter of the 3D glasses. It is also necessary to perform the corresponding operations in the similar manner with respect to any of the color filters of the 3D glasses.

The rough estimation of the spectrum transmittance function of the red filter of the 3D glasses is performed in the manner explained above. However, if the function acquired in the manner explained above is directly applied in the process of creating an anaglyph image, this will cause inaccurate color mixing and degraded quality when the 3D object is reproduced on the anaglyph image. In the known method of creating an anaglyph image using the actual spectrum transmittance function of the filter, for example, Roscolux filter function, may be used to obtain a high quality result. Accordingly, the rough estimation of the spectrum transmittance function (f) may be approximated to the function (Fi) closest to the actual filter function that is selected from a certain set.

The approximation may include the following operations. First, Fi is selected according to <Mathematical formula 4>.

$$[ Mathematical formula 4 ]$$

$${‖ {λ}_{max ( {F}_{i} )} - {λ}_{max ( f )} ‖}_{i} \to min$$

Mathematical formula 4 denotes estimation of the maximum position of a function Fi, in which Fi is the estimated left or right spectrum transmittance function (Fₗ) or (Fᵣ). In actual example, the Roscolux filter (fi) represents the estimated left (fₗ) and right (fᵣ) spectrum transmittance functions.

It is then necessary to apply the conditions to select the Roscolux filter with respect to the maximum values with the same wavelength, as expressed by:

$$[ Mathematical formula 5 ]$$

$${‖ max ( {F}_{i} ) - max ( f ) ‖}_{i} \to min$$

Mathematical formula 5 represents the closest transmittance condition.

A method for creating an anaglyph image which is adaptively applicable to certain 3D glasses and a method for printing the anaglyph image with maintaining 3D perception at the corresponding glasses have been explained above. The above-explained methods may be implemented on an image forming apparatus such as a color printer, but not limited thereto. That is, an embodiment is implementable on a separate device or a computer operating in association with the image forming apparatus, and furthermore, may be implemented by receiving a program in firmware form of a printer from a separate device such as a server. Accordingly, the methods according to embodiments are not specifically limited to certain places where these are implemented.

As a result of implementing the methods according to embodiments, it is possible to synthesize anaglyph images and printing the same in an adaptive manner depending on glasses, while maintaining 3D perception with respect to specific 3D glasses. Accordingly, color mixing is enhanced, and maximized 3D effect on the printout can be provided.

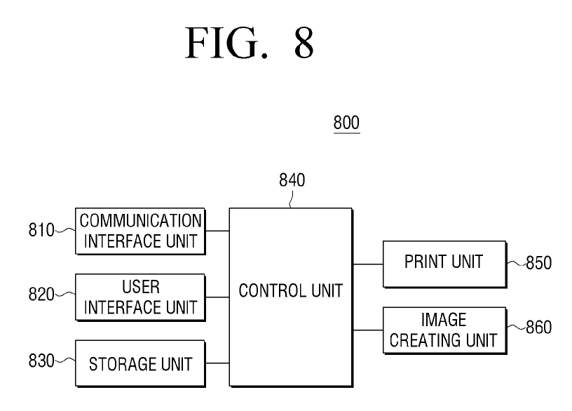

FIG. 8 is a block diagram of an image forming apparatus according to an embodiment of the present general inventive concept.

Referring to FIG. 8, the image forming apparatus according to an embodiment of the present general inventive concept may include part or all of a communication interface unit 810, a user interface unit 820, a storage unit 830, a control unit 840, a print unit 850 and an image creating unit 860. As used herein, the phrase “include part or all of” refers to an example in which the communication interface unit 810 and the user interface unit 820 are integrated with each other, or the storage unit 830 and the image creating unit 860 are integrated with each other, or some of the components are omitted. Hereinbelow, an example in which all of the above components are included will be explained for the sake of explanation.

The communication interface unit 810 may perform communication with a print control terminal, for example, a desktop computer, a laptop computer, a mobile phone, or the like, according to compatibility of the communication interface unit 810 to receive the print data with respect to a test color pattern (or stereoscopic image pattern) provided by the print control terminal. If the image forming apparatus 800 dose not store the information about the test color pattern to generate a 3D image as described above, the image forming apparatus 800 receives the color pattern-related information as provided by the print control terminal. When the color pattern information is stored, the color pattern information may be provided when there is a separate request. Given the above, an embodiment is not specifically limited to a manner of storing and printing the color pattern information.

The user interface unit 820 may include an input unit, such as a touchscreen type panel, or input buttons. The user interface unit 820 receives an estimated value about the transmittance characteristic of certain 3D glasses. As used herein, the term ‘estimated value’ may refer to a selected value of visibility and invisibility of the printed color pattern. Furthermore, the user interface unit 820 may receive additional information including geometrical aligning; color compensation; depth and disparity map estimation; image blurring by two color channels; and pixel information for range reduction of disparity or depth map of the image.

The image creating unit 860 may store a program to create a 3D image, i.e., anaglyph image. By way of example, the image creating unit 860 may create a compensated anaglyph image by executing a prestored program according to the estimated value from the user interface unit 820 and the additional information, such as the geometric aligning of the stereoscopic image. The created anaglyph image is provided to the print unit 850 and printed on a print medium under control of the control unit 840.

Other than those explained above, the components, such as the storage unit 830, the control unit 840 and the print unit 850 of FIG. 8, do not greatly differ from components, such as the storage unit 220 (to be specific, RAM 221), the control unit 210 and the print unit 230 of FIG. 2, and will not be explained in further detail for the sake of brevity.

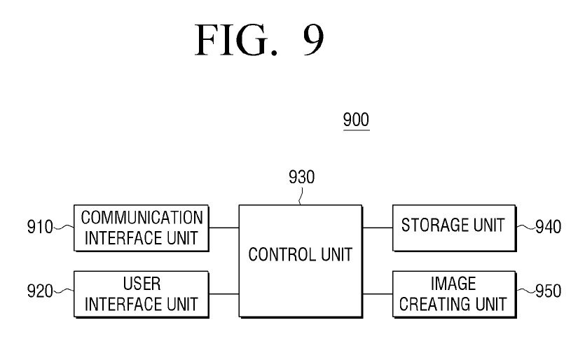

FIG. 9 is a block diagram of a printing control terminal 900 according to an embodiment of present general inventive concept.

Referring to FIG. 9, the print control terminal 900 according to an embodiment may include some or all of a communication interface unit 910, a user interface unit 920, a control unit 930, a storage unit 940 and an image creating unit 950. As used herein, the phrase “include part or all of” refers to an example in which the communication interface unit 910 and the user interface unit 920 are integrated with each other, or in which specific component(s) is omitted. Hereinbelow, an example in which all of the above components are included will be explained for the sake of explanation.

Under control of the control unit 930, the communication interface unit 910 receives print data (or pixel data) with respect to a 3D image to be stored at the storage unit 940, and furthermore, receives test color pattern-related information, and sends the data to the image forming apparatus so that the data is printed on a print medium.

Other than those explained above, the components, such as the user interface unit 920, the control unit 930, the storage unit 940, and the image creating unit 950 of FIG. 9, do not greatly differ from components, such as the user interface unit 820, the control unit 840, the storage unit 830 and the image creating unit 860 of FIG. 2, and will not be explained in further detail for the sake of brevity.

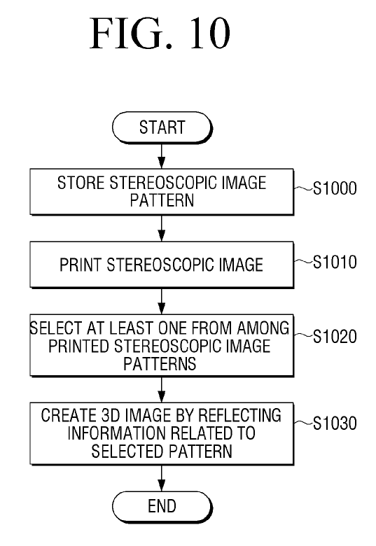

FIG. 10 is a flowchart illustrating an image forming method according to an embodiment of the present general inventive concept.

Referring to FIG. 10 along with FIG. 8 for convenience of explanation, at operation S1000, the image forming apparatus 800 stores information regarding a stereoscopic image pattern, for example, information regarding a color test pattern. As used herein, the expression ‘store’ encompasses initial storing in a manufacturing process of an image forming apparatus, storing by user, or storing in response to a separate request information received from a print control terminal such as a computer or server.

At operation S1010, the image forming apparatus 800 prints a stereoscopic image pattern, for example, in response to a user's request.

At operation S1020, the image forming apparatus 800 receives at least one pattern ‘selected’ from among the printed stereoscopic image patterns. As used herein, the expression ‘select(ed)’ may encompass an example in which a viewer determines visibility and invisibility of a stereoscopic image pattern with respect to certain 3D glasses and inputs a selected value such as transmittance function value with respect to at least one pattern as a result of determination, and additionally inputs additional information such as geometrical aligning; color compensation; depth and disparity map estimation; image blurring by two color channels; and pixel information for range reduction of disparity or depth map of the image. Depending on embodiments, the ‘select(ed)’ value may not be necessarily inputted by the user directly. That is, the image forming apparatus 800 may automatically determine and process the related operation. Accordingly, in embodiments, the expression ‘select(ed)’ is not specifically limited to the certain operations explained above.

At operation S1030, the image forming apparatus 800 reflects the selected pattern-related information such as the selected value explained above, and additional information, to create a 3D image. The created 3D image may then be printed on a printout (print medium) and outputted thereto.

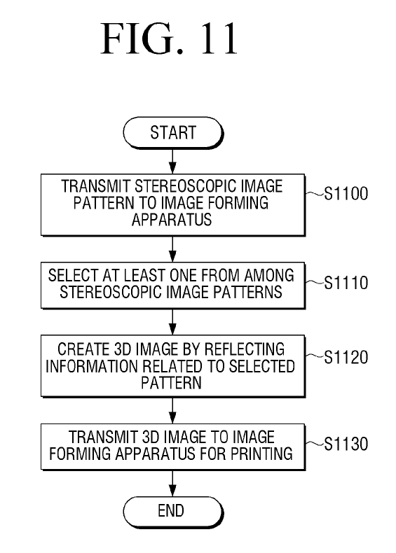

FIG. 11 is a flowchart illustrating a method of controlling printing according to an embodiment of the present general inventive concept.

Referring to FIG. 11 along with FIG. 9 for convenience of explanation, at operation S1100, the print control terminal 900 transmits the stereoscopic image pattern, i.e., the information regarding the test color pattern to the image forming apparatus. Accordingly, the image forming apparatus prints the corresponding stereoscopic image pattern on a printout.

At operation S1110, the print control terminal 900 receives at least one pattern selected from among the printed stereoscopic image patterns. Since the term ‘selected’ is already explained above with reference to FIG. 10, this will not be additionally explained for the sake of brevity.

At operation S1120, the print control terminal 900 reflects the information related to the selected pattern and creates 3D image. Since the information related to the selected pattern has been explained above with reference to FIG. 10, this will not be additionally explained for the sake of brevity.

At operation S1130, the print control terminal 900 transmits the created 3D image (for example, data regarding an image) to the image forming apparatus. Accordingly, the image forming apparatus prints the corresponding 3D image data on a printout (print medium).

While it is explained above that all the components according to an embodiment are connected to each other or operate in association with each other, the present general inventive concept is not limited thereto. That is, within the scope of the object aimed by the present general inventive concept, it is possible that one or more selected from among the components operate in association with each other. Further, while all the components may be respectively implemented as an independent hardware, it is also possible that some or all of the components are selectively combined and implemented as a computer program having a program module which performs some or all of the combined functions on one or a plurality of hardware. Codes and code segments constructing the computer program may be easily inferred by those skilled in the art to which the general inventive concept pertains. The computer program may be stored on a computer readable medium to be read out and executed, to thus implement the present general inventive concept. The computer readable medium may include a computer readable recording medium and a computer readable transmission medium. The computer-readable recording medium is any data storage device that can store data as a program which can be thereafter read by a computer system. Examples of the computer-readable recording medium include a semiconductor chip device, a read-only memory (ROM), a random-access memory (RAM), a flash memory, CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
a storage unit to store stereoscopic image patterns to be used for creation of a three dimensional (3D) image;
a print unit to print the stereoscopic image patterns;
a user interface unit to select at least one pattern of the stereoscopic image patterns; and
an image creating unit to create the 3D image by reflecting information related to the selected at least one pattern.

2. The image forming apparatus of claim 1, wherein the user interface unit performs at least one of: manual stereo-pair aligning to create the 3D image; parallax change to change depth of the 3D image; estimation of transmittance characteristic of 3D glasses; and adjustment of image size, to thereby reflect the information.

3. The image forming apparatus of claim 2, wherein the image creating unit creates an anaglyph image as the 3D image, and the 3D glasses use an anaglyph manner.

4. The image forming apparatus of claim 2, wherein the information according to the estimation of the transmittance characteristic of the 3D glasses comprises a result of determining visibility and invisibility of the stereoscopic image pattern through the 3D glasses.

5. The image forming apparatus of claim 1, wherein the user interface unit executes an algorithm to adjust the information so that certain 3D glasses are adaptively used.

6. An image forming method, comprising:
storing stereoscopic image patterns to be used for creation of a three dimensional (3D) image;
printing the stereoscopic image patterns;
selecting at least one pattern of the stereoscopic image patterns; and
creating the 3D image by reflecting information related to the selected at least one pattern.

7. The image forming method of claim 6, further comprising:
estimating spectrum transmittance with respect to 3D glasses viewing the 3D image, using the stereoscopic image patterns;
adjusting image information regarding the stereoscopic image of the 3D image; and
creating the 3D image with respect to the stereoscopic image, using the estimated spectrum transmittance and the adjusted image information.

8. The image forming method of claim 7, wherein the estimating of the spectrum transmittance comprises:
estimating a spectrum transmittance function with respect to a left-side filter of the 3D glasses;
estimating a spectrum transmittance function with respect to a right-side filter of the 3D glasses; and
approximating a function estimate with respect to the spectrum transmittance functions of the left- and right-side filters.

9. The image forming method of claim 7, wherein the adjusting of the image information comprises:
geometrically aligning left- and right-eye images of the stereoscopic image;
compensating color of the left- and right-eye images;
blurring at least one of two color channels of the left- and right-eye images;
estimating a disparity map;
correcting the disparity map to reduce a disparity value that exceeds a preset threshold; and
changing the left- and right-eye images according to the corrected disparity map.

10. The image forming method of claim 7, wherein the adjusting of the image information comprises:
geometrically aligning left- and right-eye images of the stereoscopic image;
compensating color of the left- and right-eye images;
blurring at least one of two color channels of the left- and right-eye images;
determining if a depth map exceeds a preset threshold and correcting the depth map to reduce a range of depth value of a stage according to the determination; and
changing the left- and right-eye images according to the corrected depth map.

11. The image forming method of claim 9, wherein a variable at the blurring, a variable at the changing of the disparity map, and the depth map are determined according to a size of the 3D image.

12. The image forming method of claim 6, wherein the printing of the stereoscopic image patterns comprises printing a series of colors having at least one of frequency, saturation and hue that is different from each other.

13. A print control terminal connectible to an image forming apparatus, the print control terminal comprising:
a storage unit to store stereoscopic image patterns to be used for creation of a three dimensional (3D) image;
a user interface unit to select at least one pattern of stereoscopic image patterns printed by the image forming apparatus;
an image creating unit to create the 3D image by reflecting information related to the selected at least one pattern; and
a communication interface unit to transmit the stereoscopic image pattern and the created 3D image to the image forming apparatus.

14. The print control terminal of claim 13, wherein the user interface unit performs at least one of: manual stereo-pair aligning to create the 3D image; parallax change to change depth of the 3D image; estimation of transmittance characteristic of 3D glasses; and adjustment of image size, to thereby reflect the information.

15. The print control terminal of claim 14, wherein the information according to the estimation of the transmittance characteristic of the 3D glasses comprises a result of determining visibility and invisibility of the stereoscopic image pattern through the 3D glasses.

16. A method of print controlling in a print control terminal, the method comprising:
transmitting stereoscopic image patterns to be used for creation of a three dimensional (3D) image to an image forming apparatus;
selecting at least one pattern of stereoscopic image patterns printed by the image forming apparatus;
creating the 3D image by reflecting information related to the selected at least one pattern; and
transmitting the stereoscopic image pattern and the created 3D image to the image forming apparatus.

17. The method of claim 16, wherein:
the receiving of the at least one pattern comprises:
estimating a spectrum transmittance with respect to a three dimensional (3D) glasses viewing the 3D image, using the stereoscopic image patterns, and
adjusting image information with respect to the stereoscopic image of the 3D image; and
the creating of the 3D image comprises:
creating the 3D image with respect to the stereoscopic image using the estimated spectrum transmittance and the adjusted image information.

18. The method of claim 17, wherein the estimating of the spectrum transmittance comprises:
estimating a spectrum transmittance function with respect to a left-side filter of the 3D glasses;
estimating a spectrum transmittance function with respect to a right-side filter of the 3D glasses; and
approximating a function estimate with respect to the spectrum transmittance functions of the left- and right-side filters.

19. The method of claim 17, wherein the adjusting of the image information comprises:
geometrically aligning left- and right-eye images of the stereoscopic image;
compensating color of the left- and right-eye images;
blurring at least one of two color channels of the left- and right-eye images;
estimating a disparity map;
correcting the disparity map to reduce a disparity value that exceeds a preset threshold; and
changing the left- and right-eye images according to the corrected disparity map.

20. The method of claim 17, wherein the adjusting of the image information comprises:
geometrically aligning left- and right-eye images of the stereoscopic image;
compensating color of the left- and right-eye images;
blurring at least one of two color channels of the left- and right-eye images;
determining if a depth map exceeds a preset threshold, and correcting the depth map to reduce a range of depth value of a stage according to the determination; and
changing the left- and right-eye images according to the corrected depth map.

21. The method of claim 19, wherein a variable at the blurring, a variable at the changing of the disparity map, and the depth map are determined according to a size of the 3D image.

22. The method for controlling of claim 16, wherein the transmitting of the stereoscopic image patterns comprises transmitting stereoscopic image patterns including a series of colors having at least one of frequency, saturation and hue that is different from each other.

23. A non-transitory computer readable medium to contain computer-readable codes as a program to execute an image forming method, the image forming method comprising:
storing stereoscopic image patterns to be used for creation of a three dimensional (3D) image;
printing the stereoscopic image patterns;
selecting at least one pattern of the stereoscopic image patterns; and
creating the 3D image by reflecting information related to the selected at least one pattern.

24. A method of an image forming apparatus, comprising:
creating a 3D image using information of at least one stereoscopic image pattern associated with a spectrum transmittance characteristic of 3D glass; and
printing the created 3D image on a print medium.
